(19) United States
(12) Patent Application Publication
(10) Pub. No.: US 2026/0153168 A1
(43) Pub. Date: Jun. 4, 2026

(54) INDUCTION HEAT AND HEATING

(71) Applicant: Polyflow LLC, Midland, TX (US)

(72) Inventors: Malcolm Rosenow, Aiken, SC (US); Matthew Leonard Ryan, The Woodlands, TX (US); Liang Yu, Katy, TX (US); Eugene Boakye-Firempong, Houston, TX (US); Roberto Barrientos, Houston, TX (US); Ana Alves, Houston, TX (US)

(21) Appl. No.: 18/965,881

(22) Filed: Dec. 2, 2024

(51) Int. Cl. F16L 11/08; B29C 48/00; B29L 23/00

(52) U.S. Cl. CPC F16L 11/081; B29C 48/0019; B29L 2023/005

(57) ABSTRACT

A flexible pipe member, a tape element, and a method of manufacturing a flexible pipe member are disclosed. The flexible pipe member comprises a liner region; an outer sheath region; and an intermediate region between the liner region and the outer sheath region; wherein the intermediate region comprises a plurality of radially spaced apart ranks of metallic strand elements embedded in polymer matrix material and at least one spacer element, infiltrated with the matrix material, that provides a standoff between respective metallic strand elements in adjacent radially outer and radially inner ranks of the plurality of ranks.

### FIELD

The present invention relates to multilayer flexible pipe that has at least one spacer element within the body of the pipe, and apparatus and a method for consolidating multilayer pipe. In particular, but not exclusively, embodiments disclosed herein relate to consolidating previously unbonded layers in flexible pipe body using a spacer element such as a layer of mesh between layers to prevent radially spaced apart ranks of axially extending metal wires located in the pipe body from touching during consolidation.

### BACKGROUND

Many types of flexible pipe are used from time to time to transport fluids in the oil and gas industry. Sometimes, reinforced thermoplastic pipe (RTP) is used for such a purpose. For example, RTP may transport production oilfield fluids, such as water, gas, hydrocarbon liquids, or the like from one location to another. RTP are usually used onshore (overland) but they may also be used in very shallow water applications (for example less than 50 m water depth). There are two main forms of RTP: unbonded RTP, in which RTP body has individual concentric layers that are free to move relative to one another, and bonded RTP, which has concentric regions that are consolidated and move together. Sometimes bonded RTP may be called thermoplastic composite pipe (TCP). TCPs are sometimes used for offshore applications.

Moving from its radially innermost layer outwards, unbonded RTP usually has an inner fluid retaining polymer liner (so called “liner”) followed by a reinforcement layer followed by an outer fluid containing polymer sheath (so called “protective sheath”). Various types of RTP are defined in American Petroleum Institute Specification 15S (API 15S). The liner and protective sheath layers are usually extruded tubes formed of one or more types of polymer. In some applications the inner polymer layer may have sub-layers with similar or different polymer compositions which are co-extruded to form a liner.

Unbonded RTP body may be manufactured by progressively wrapping tape of a reinforcement layer over the previous layer, starting from the innermost layer and finishing with the outermost layer. The innermost layer of RTP body is often formed by extrusion. Parameters such as lay angle and the like may be varied according to any requirements of the layer being wound. This process of wrapping the layer around the previous layer may be referred to as a winding phase. The output of the winding phase is typically fed through an extruder to provide an outer protective sheath of polymer, the RTP body, can then be spooled and transported.

Conventionally, bonded RTP body is manufactured using a similar process to the process used for unbonded RTP body, except in addition, layers of RTP body are bonded or consolidated during or after the winding phase and/or during final sheath extrusion. Thus, bonded RTP may have a similar construction, except that the layers of unbonded RTP are now bonded regions. According to one conventional approach, as reinforced tape is wound around the internal fluid retaining layer of RTP body, a heat source (typically hot air, or radiant heat from an infra-red source, or using a laser) is applied to soften the polymer in the reinforced tape, and/or the outer surface of the internal fluid retaining layer, to allow the reinforced tape to bond to the layer below.

There has been some interest in forming bonded RTP body by consolidating a fully assembled unbonded RTP body. This process is potentially simpler and quicker than alternatives. It also enables unbonded RTP body to be stored and then consolidated at a later date or as a separate manufacturing node. In either case, the bonded RTP body that is produced still has bonded regions that correspond to the layers of unbonded RTP body.

One approach for consolidating fully assembled unbonded RTP body is by using induction heating. An electromagnet may be used to induce a current through metal components in the unbonded RTP body thereby raising their temperature sufficiently to consolidate the body. However, using induction heating to consolidate unbonded RTP body has some shortcomings. The quality of bonding between regions of bonded RTP body may be lower than traditional techniques. This may prevent the bonded RTP body from meeting certain performance standards (e.g. minimum temperature and pressure requirements), or make it more vulnerable to catastrophic failure, or simply less durable.

Attempts to address these shortcomings, such as slowly passing the electromagnet along the unbonded RTP body, or performing repeated passes of the electromagnet, have been somewhat successful but have had problems. Additionally, some metal components in the unbonded RTP body may effectively block underlying metal components from being induction heated to a sufficient temperature. This is particularly problematic when more than two metal components lie between the electromagnet and the target metal component in the unbonded RTP body. During induction heating, the temperature distribution across the unbonded RTP body can reach unsustainable levels, causing irreversible damage to polymer components of the body and/or failing to bond layers of the unbonded RTP body. As such, induction heating has been limited to consolidating simple unbonded RTP body having two or fewer layers containing metal components.

### SUMMARY

It is an aim of certain embodiments disclosed herein to at least partly mitigate one or more of the above-mentioned problems.

It is an aim of certain embodiments disclosed herein to control and improve the quality of bonding between regions of bonded RTP body formed by induction heating fully assembled unbonded RTP body.

It is an aim of certain embodiments disclosed herein to provide apparatus that makes induction heating a viable method for consolidating unbonded RTP body that has over two concentric layers each containing metal wires.

It is an aim of certain embodiments disclosed herein to provide apparatus and a method for increasing the efficiency of induction heating fully assembled unbonded RTP body.

It is an aim of certain embodiments disclosed herein to provide apparatus and a method for reducing the time taken to consolidate fully assembled unbonded RTP body by induction heating.

It is an aim of certain embodiments disclosed herein to provide a method of consolidating multilayer RTP body having four or more layers of steel wire by induction heating.

It is an aim of certain embodiments disclosed herein to provide a method of induction heating fully assembled unbonded RTP body, whereby a desired temperature can be stably controlled at a predetermined location within the body. Preventing rapid spikes in temperature and/or providing a more even temperature distribution throughout the unbonded RTP body helps to avoid damage to more temperature-sensitive components.

It is an aim of certain embodiments disclosed herein to provide apparatus for ensuring the temperature distribution of unbonded RTP body during induction heating does not exceed a predetermined maximum value.

It is an aim of certain embodiments disclosed herein to provide a method of induction heating unbonded RTP body whereby the temperature at a predetermined location of the body is between a predetermined threshold (minimum) value and a predetermined ceiling (maximum) value.

According to a first aspect there is provided a flexible pipe member, comprising:
a liner region;
an outer sheath region; and
an intermediate region between the liner region and the outer sheath region;
wherein
the intermediate region comprises a plurality of radially spaced apart ranks of metallic strand elements embedded in polymer matrix material and at least one spacer element, infiltrated with the matrix material, that provides a standoff between respective metallic strand elements in adjacent radially outer and radially inner ranks of the plurality of ranks.

In certain embodiments, the spacer element is made from electrically insulating or electrically non-conductive material.

In certain embodiments, the spacer element is made from a material with an electrical resistance or electrical impedance or electrical resistivity that is greater than a respective electrical resistance or electrical impedance or electrical resistivity associated with the metallic strand elements, or that is greater than a respective electrical resistance or electrical impedance or electrical resistivity of at least two of the metallic strand elements when said at least two of the metallic strand elements are in contact.

In certain embodiments, the electrical resistance or electrical impedance or electrical resistivity of the spacer element is at least twice the respective electrical resistance or electrical impedance or electrical resistivity associated with the metallic strand elements, or is at least twice the respective electrical resistance or electrical impedance or electrical resistivity associated with said at least two of the metallic strand elements when said at least two of the metallic strand elements are in contact.

In certain embodiments, the spacer element is made from a material with an electrical conductance or electrical conductivity that is less than a respective electrical conductance or electrical conductivity associated with the metallic stand elements, or is less than a respective electrical conductance or electrical conductivity associated with at least two of the metallic strand elements when said at least two of the metallic strand elements are in contact.

In certain embodiments, the electrical conductance or electrical conductivity of the spacer element is less than 10% of the respective electrical conductance or electrical conductivity associated with the metallic strand elements, or is less than 10% of the respective electrical conductance or electrical conductivity associated with said at least two of the metallic strand elements when said at least two of the metallic strand elements are in contact.

In certain embodiments, one or more respective spacer elements of the at least one spacer element comprises a respective spacer web.

In certain embodiments, the spacer web comprises a plurality of filaments.

In certain embodiments, the plurality of radially spaced apart ranks of metallic strand elements are circumferentially extending ranks.

In certain embodiments, the intermediate region comprises a plurality of metallic strand elements helically wound in ranks that each extend axially along the flexible pipe body at a respective predetermined radially constant distance from a central axis associated with a central bore of the flexible pipe body.

In certain embodiments, each spacer element of the at least one spacer element extends as a perforated tube axially along the flexible pipe member and is disposed at a constant radius.

In certain embodiments, the at least one spacer element comprises a plurality of spacer elements each comprising a respective perforated tube, each perforated tube extending at a respective constant radius along the flexible pipe body between a respective two of the plurality of ranks.

In certain embodiments, each respective perforated tube has a respective diameter associated with that tube, and each respective diameter is different in size to a diameter of any other respective perforated tube.

In certain embodiments, each respective perforated tube is coaxially arranged with each remaining respective perforated tube.

In certain embodiments, a first perforated tube is disposed radially around a radially innermost rank of the plurality of ranks, and a further perforated tube is disposed radially around the first perforated tube and radially inside of a radially outermost rank of the plurality of ranks.

In certain embodiments, the polymer matrix material of the intermediate region infiltrates between filaments of the at least one spacer web along at least a portion of a length of the flexible pipe member.

In certain embodiments, the liner region comprises a tubular region of a polymer liner material; and
the outer sheath comprises a tubular region of a polymer sheath material; and
the polymer matrix material is respectively consolidated with the liner material and the sheath material at respective interfaced zones where the liner region blends into the matrix material of the intermediate region and where the outer sheath region material blends into the matrix material of the intermediate region.

According to a second aspect there is provided a tape element, comprising:
a flexible elongate polymer tape body having a first edge spaced apart from a remaining edge;
a plurality of metallic strand elements embedded in, and extending axially in a parallel spaced apart relationship within, the tape body; and
at least one flexible spacer element each supported on a respective one side of the tape body.

In certain embodiments, the spacer element comprises a spacer web.

In certain embodiments, the spacer web comprises a strip comprising a plurality of interwoven or interconnected filaments.

In certain embodiments, the spacer element comprises a 3D knit or weave or fabric or cloth or grid or porous sheet or mesh or integrally formed mesh or web or the like.

In certain embodiments, the spacer element is manufactured from an electrically insulating material.

In certain embodiments, a material of the spacer element has a melt temperature of more than 120° C.

In certain embodiments, a material of the spacer element has a melt temperature of more than 135° C.

In certain embodiments, a material of the spacer element has a melt temperature of more than 200° C.

In certain embodiments, a material of the spacer element has a melt temperature equal to or greater than a melt temperature associated with an underlying layer over which the tape element is wound.

In certain embodiments, a material of the spacer element has a melt temperature equal to or greater than a melt temperature associated with a layer adjacent to the tape element in unbonded flexible pipe body, that is intended to be consolidated by heating.

In certain embodiments, the spacer element comprises a plurality of through openings that extend from a first side of the spacer element proximate to said a respective one side of the tape body to a remaining side of the spacer web distal to said a respective side.

In certain embodiments, the spacer web comprises an integrally formed mesh.

In certain embodiments, the mesh, in an uncompressed innate form, is undulating in both a transverse direction across a width of the tape body and also in a longitudinal direction aligned with an elongate axis associated with the tape body.

In certain embodiments, the flexible elongate polymer tape body is a windable elongate polymer tape body and the at least one flexible spacer element is at least one respective windable flexible spacer element.

According to a third aspect there is provided a method of manufacturing a flexible pipe member, comprising the steps of:
extruding a tubular layer of a polymer liner material thereby providing a tubular liner;
providing a plurality of layers of windings over the liner, each layer of the layers of windings being provided by helically winding a respective tape element, that comprises a plurality of metallic strand elements embedded in and axially extending in a spaced apart substantially parallel relationship within an elongate polymer tape body, over an underlying layer;
extruding a tubular layer of a polymer outer sheath material as an outer sheath over an outer layer of the layers of windings;
via induction heating, heating at least a predetermined axial length of said a plurality of layers of windings, thereby melting and consequently consolidating tape body material that comprises polymer material of polymer from the tape body of the layers of windings; and
as the tape body material melts, providing a standoff between metallic strand elements in adjacent ranks of metallic strand elements, each rank being associated with embedded metallic strand elements of tape windings of a respective one of the plurality of layers of windings.

In certain embodiments, the method further comprises:
via providing the standoff between metallic strand elements in adjacent ranks of metallic strand elements, providing an electrically insulating or electrically non-conductive standoff between metallic strand elements in adjacent ranks of metallic strand elements.

In certain embodiments, the method further comprises:
via providing the standoff between metallic strand elements in adjacent ranks of metallic strand elements, providing a standoff, between metallic strand elements in adjacent ranks of metallic strand elements, that has an electrical resistivity or electrical impedance or electrical resistance that is greater than a respective electrical resistivity or electrical impedance or electrical resistance associated with the metallic strand elements, or that has an electrical conductance or electrical conductivity that is less than a respective electrical conductance or electrical conductivity associated with the metallic strand elements.

In certain embodiments, the method further comprises:
providing at least one spacer element between metallic strand elements of at least one pair of adjacent ranks prior to extruding the outer sheath.

In certain embodiments, the method further comprises:
providing at least one spacer element between at least one pair of adjacent layers of windings.

In certain embodiments, the method further comprises:
providing at least one spacer element by providing at least one spacer web.

In certain embodiments, the method further comprises:
providing a respective spacer element between metallic strand elements of each pair of adjacent ranks.

In certain embodiments, the method further comprises:
providing the standoff between metallic strand elements in adjacent ranks of metallic strand elements via providing a standoff between metallic strand elements in adjacent circumferentially arranged ranks of metallic strand elements.

In certain embodiments, the method further comprises:
providing the spacer element by winding a first tape element that comprises a spacer element strip supported on at least one side of the tape element prior to winding a further tape element of the next respective layer thereby providing the standoff.

In certain embodiments, the method further comprises:
prior to winding a further tape element of the next respective layer, providing the spacer element by winding a first tape element that comprises a first spacer element strip supported a first side of the tape element, and a further spacer strip supported on a further side of the tape element, that is an opposite side relative to the first side, thereby providing the standoff.

In certain embodiments, the method further comprises:
providing the spacer element by winding a tape element of a respective layer and subsequently providing a spacer element strip over the tape element windings prior to winding a next tape element of a next respective layer over the spacer element strip.

In certain embodiments, the method further comprises:
providing the spacer element by winding the spacer element strip over the tape element windings prior to winding a next tape element of a next respective layer over the spacer element strip.

In certain embodiments, the method further comprises:
heating the at least a predetermined axial length of said a plurality of layers of windings via imparting an electrical current in a coil element disposed radially outside of the outer sheath or radially inside the tubular liner, thereby inducing an electrical current in at least one of the metallic strand elements.

In certain embodiments, the method further comprises:
inducing an electrical current in at least one of the metallic strand elements comprises inducing an electrical current in each of the metallic strand elements of each rank.

In certain embodiments, the method further comprises:
imparting an electrical current in the coil element comprises imparting an electrical current in at least one turn of a coil element that comprises at least one turn formed from electrically conducting material.

In certain embodiments, the method further comprises:
axially moving at least a portion of an axial length of the tubular liner with respect to the coil element thereby heating at least one of the metallic strand elements disposed radially around said at least a portion of the axial length of the tubular liner.

In certain embodiments, the method further comprises:
axially moving the coil along at least a portion of an axial length of the tubular liner to thereby heat a region of at least one of the metallic strand elements disposed radially around said at least a portion of the axial length of the tubular liner.

In certain embodiments, the method further comprises:
via providing a plurality of layers of windings over the liner, providing an intermediate zone that comprises the plurality of layers of windings.

According to a fourth aspect there is provided a flexible pipe member, comprising:
a liner region;
an outer sheath region; and
an intermediate region between the liner region and the outer sheath region;
wherein
the intermediate region comprises a plurality of radially spaced apart rows of metal strand elements embedded in polymer matrix material and at least one spacer element, infiltrated with the matrix material, that provides a standoff between respective metal strand elements in adjacent radially outer and radially inner ranks of the plurality of rows.

According to a fifth aspect there is provided a tape element, comprising:
a flexible elongate polymer tape body having a first edge spaced apart from a remaining edge;
a plurality of metal strand elements embedded in, and extending axially in a parallel spaced apart relationship within, the tape body; and
at least one flexible spacer element each supported on a respective one side of the tape body.

According to a sixth aspect there is provided a method of manufacturing a flexible pipe member, comprising the steps of:
extruding a tubular layer of a polymer liner material thereby providing a tubular liner;
providing a plurality of layers of windings over the liner, each layer of the layers of windings being provided by helically winding a respective tape element, that comprises a plurality of metal strand elements embedded in and axially extending in a spaced apart substantially parallel relationship within an elongate polymer tape body, over an underlying layer;
extruding a tubular layer of a polymer outer sheath material as an outer sheath over an outer layer of the layers of windings;
via induction heating, heating at least a predetermined axial length of said a plurality of layers of windings, thereby melting and consequently consolidating tape body material that comprises polymer material of polymer from the tape body of the layers of windings; and
as the tape body material melts, providing a standoff between metal strand elements in adjacent rows of metal strand elements, each row being associated with embedded metal strand elements of tape windings of a respective one of the plurality of layers of windings.

Certain embodiments provide apparatus that facilitates material of more than two stacked layers of tape, each having strands of metal wire, being consolidated by induction heating.

Certain embodiments provide a method for consolidating unbonded RTP body using induction heating that increases the uniformity of bonding between regions of bonded RTP body, particularly when the bonded RTP body contains more than two radially spaced apart ranks of metal wire. Surprisingly it has been found that when metal wires in different tape layers of unbonded RTP body touch during induction heating using a known technique, the effectiveness of an induction heater at heating the whole of the unbonded RTP body to the correct temperature drops significantly. In fact, normally the metal wires in the two tape layers closest to an induction heating coil of the heater begin to heat significantly more than expected whilst the metal wires in the underlying tape layers do not heat enough. The method(s) provided by certain embodiments help to address these problems.

With such a prior known technique, it has now been appreciated that when the induction heating coil is positioned outside the unbonded RTP body for induction heating and the metal wires touch, the tape body of the two outer tape layers heats too much, which may permanently negatively affect its properties. Meanwhile, the two inner tape layers are sometimes not heated enough to soften their tape bodies for bonding to neighbouring layers. Changing the frequency of the current through the induction heating coil (and thus changing the properties of the magnetic field created by the coil) or increasing the number of passes of the induction heating coil does not alone solve the problem. In contrast, maintaining a gap between metal wires according to certain embodiments of the present invention prevents electrical current from passing between the metal wires. Due to the insulative nature of the spacer elements, electrical current is prevented from passing between the metal wires via the lining (at least to any measurable degree). As such the quality of bonding in bonded RTP body is improved relative to a known technique by using the lengths of spacer element.

Certain embodiments provide apparatus that prevents steel wires each contained in respective concentric axially extending tapes of unbonded RTP body from electrically interconnecting. This is advantageous during induction heating of unbonded RTP body because current induced in one steel wire cannot flow to a neighbouring steel wire.

Certain embodiments provide bonded RTP body having four or more radially spaced apart steel wires embedded in polymer matrix material. Each steel wire extends along an axial dimension of the body and does not touch a neighbouring steel wire. By maintaining a gap using a standoff between each steel wire during consolidation via induction heating, the adhesion between regions, a jacket, and an inner liner can be improved.

Certain embodiments provide bonded RTP body having an axial cross-section with four or more spaced apart ranks of steel wires embedded in polymer matrix material. Aptly such a configuration can be formed by induction heating whilst maintaining a uniform degree of bonding across the cross-section.

Certain embodiments provide apparatus that enables unbonded RTP body containing more than two layers of concentric axially extending tape each having a metal wire to be consolidated by a single induction heating process.

Certain embodiments provide a method that prevents neighbouring layers of radially spaced apart metal wires in unbonded RTP body from touching one another during an induction heating process for body consolidation. The wires thus remain electrically isolated during induction heating. This helps to reduce the blocking/shielding effect of one metal wire or a set of wires on the magnetic field passing through an underlying metal wire being induction heated.

Certain embodiments provide a method of consolidating unbonded RTP body containing more than two radially spaced apart metal wires using a non-contact heating method. This is advantageous because having more than two layers of intermediate tape each containing a metal wire tends to increase the pressure resistance of the RTP body.

Certain embodiments provide a method of consolidating unbonded RTP body containing more than two radially spaced apart metal wires using induction heating whereby a single source of changing magnetic field is located outside an outer surface on the unbonded RTP body. This is advantageous because providing a source of changing magnetic field inside an inner bore of the unbonded RTP body is inconvenient.

Certain embodiments prevent metal strand elements in layers of unbonded pipe body and surrounded by matrix material from touching during a pipe body consolidation process. It has now been found that using the known techniques, as the matrix material in which wires are held in the unbonded layers melts, the wires can migrate and on occasion touch. Thus, during induction heating, the temperature distribution across the unbonded RTP body can reach unsustainable levels, causing irreversible damage to polymer components of the body and/or failing to bond layers of the unbonded RTP body. Likewise the interconnection of wires used to create heat can create a shield like effect which prevents heating via other wires that are set apart from the induction coil (whether on the inside or outside of the pipe body).

By contrast and helpfully, according to certain embodiments of the present invention, a spacer element maintains a gap of a predetermined thickness between neighbouring ranks of metal strand elements when the unbonded pipe body is consolidated during induction heating. The spacer element thus has a higher melting point than material adjacent to the spacer element that is softened/melted during consolidation. It has now been found that when known induction heating processes cause a tape body that the metal strand elements are contained within to soften, the metal strand elements are able to move through the softened pipe body somewhat. The metal strand elements have a tendency to move in one direction (e.g. due to gravity). The spacer element advantageously prevents the metal strand elements from touching.

### BRIEF DESCRIPTION OF THE DRAWINGS

Certain embodiments of the present disclosure will now be described hereinafter, by way of example only, with reference to the accompanying drawings in which:

FIG. 1 illustrates a section view of a segment of bonded reinforced thermoplastic pipe (RTP) body;

FIG. 2 illustrates certain uses of RTP;

FIG. 3 illustrates an axial cross-section of bonded RTP body; and

FIG. 4 illustrates a tape element having a windable spacer element;

FIGS. 5 to 7 illustrate how unbonded RTP body may be made;

FIG. 8 illustrates a segment of unbonded RTP body;

FIG. 9 illustrates a longitudinal cross-section of a segment of unbonded RTP body;

FIG. 10 illustrates how unbonded RTP body may be consolidated;

FIG. 11 illustrates an induction heating process for consolidating unbonded RTP body;

FIG. 12 illustrates a longitudinal cross-section of a segment of bonded RTP body;

FIG. 13 illustrates a flexible spacer element;

FIG. 14 illustrates making alternative unbonded RTP body.

In the drawings like reference numerals refer to like parts.

### DETAILED DESCRIPTION

Throughout this description, reference will be made to a type of flexible pipe known as reinforced thermoplastic pipe (RTP). It is to be appreciated that certain embodiments may also be applicable to use with a wide variety of flexible pipe/flexible pipe members. For example, certain embodiments can also be used with respect to flexible pipe body and associated end fittings of the type which is manufactured according to API 17J. Such flexible pipe is often referred to as unbonded flexible pipe. Certain embodiments may also be used with respect to thermoplastic composite pipe (TCP).

Discussed below are examples for how unbonded RTP body may be consolidated using induction heating whereby metal wires present in each of at least two layers of the unbonded RTP body are prevented from making electrical contact. It will be appreciated that other applications for this approach may be applicable outside of unbonded RTP body, with different apparatus for preventing the wires from contacting, or the like.

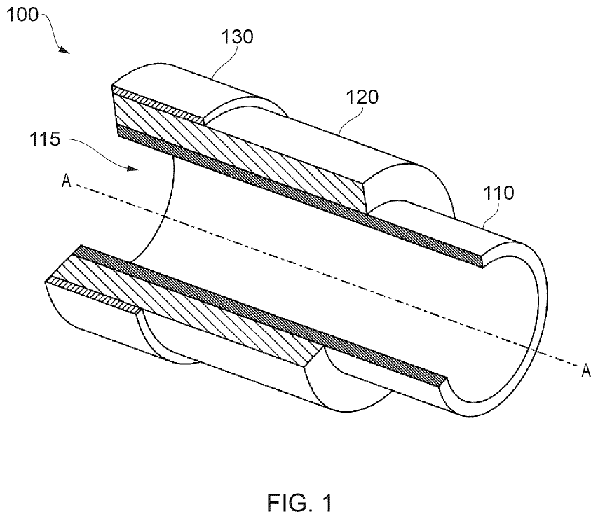

It will be understood that the illustrated RTPs are an assembly of a portion of RTP body and one or more end fittings (not shown) in each of which a respective end of RTP body is terminated. FIG. 1 illustrates bonded pipe body 100, which may be formed by consolidating an unbonded pipe body having a combination of layered materials that form a pressure-containing conduit according to a first embodiment. RTP body 100 has a central axis marked by A-A in FIG. 1. Although a number of particular regions are illustrated in FIG. 1, it is to be understood that certain embodiments are broadly applicable to coaxial pipe body structures including two or more layers manufactured from a variety of possible materials. Bonded pipe body 100 may include one or more regions comprising composite materials, forming a tubular composite region. It is to be further noted that the layer thicknesses are shown for illustrative purposes only. As used herein, the term “composite” is used to broadly refer to a material that is formed from two or more different materials, for example a material formed from a matrix material and reinforcement fibres. Pipe body may include one or more layers of a single material, forming a tubular uniform layer.

A tubular composite layer is thus a layer having a generally tubular shape formed of composite material. Alternatively, a tubular composite layer is a layer having a generally tubular shape formed from multiple components one or more of which is formed of a composite material. The layer or any element of the composite layer may be manufactured via an extrusion, pultrusion or deposition process or, by a winding process in which adjacent windings of tape which themselves have a composite structure are bonded together with adjacent windings.

The RTP body 100 illustrated in FIG. 1 is an example of a flexible pipe member. The RTP body 100 includes a fluid retaining liner region 110 which is non-porous and thus provides a boundary for any conveyed fluid. The liner region 110 is tubular and made of high-density polyethylene (HDPE), defining an internal pipe bore 115 of the RTP body. It will be appreciated that the liner region 110 may be formed by consolidating an internal fluid retaining layer, which may be formed by extruding HDPE into a tubular shape. It will be appreciated that in other embodiments, the liner region 110 may be made of a different polymer (for example polyethylene, polypropylene, polyamide, or the like). Additionally it will be appreciated that there are alternatives to extrusion for manufacturing a tubular layer. It is to be understood that the liner region 110 may itself comprise a number of sub-regions in some embodiments.

The internal diameter of the liner region 110 shown—which may also be referred to as the bore 115—is 6 inches (152.4 mm). In use the bore 115 constrains fluid that passes through the RTP body 100. It will be appreciated that in other embodiments the internal diameter of the pipe bore 115 may be larger or smaller in diameter. The pipe bore 115 of RTP body 100 is hollow. Bore fluid is able to flow in a direction broadly parallel with the central axis A-A of RTP body 100. It will be appreciated that RTP body 100 may be deformed by external or internal forces without breaking. External forces may deform RTP body 100 and determine a shape adopted by the RTP.

The embodiment of RTP body as shown in FIG. 1 includes an intermediate reinforcement region 120. The intermediate region 120 provides structural support to RTP body 100. The intermediate region 120 may help to improve the resistance of RTP body to internal or external pressures, tensile forces, torsion, or the like. The intermediate region 120 is coaxial and radially external to the liner region 110. As shown in FIG. 1, the intermediate region 120 is bonded with the liner region 110. It will be appreciated that in some embodiments, the intermediate region 120 may be composed of a plurality of sub-regions. The sub-regions may be formed from individual layers of unbonded RTP body that are consolidated into one region.

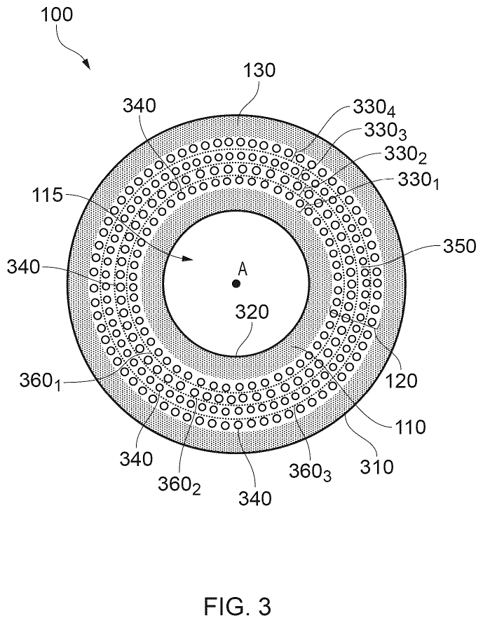

In FIG. 1, the intermediate region 120 is mainly built up of four ranks of steel wires embedded in a matrix of high density polyethylene (detail not shown). Each rank of steel wires is arranged in a respective concentric circle such that an inner rank is radially innermost to the RTP body 100 in the intermediate region 120 whilst an outer rank is radially outermost to the RTP body 100 in the intermediate region. The ranks of metal wires are aligned with the central axis A-A of the body 100, although alternatively they may be helically wound at an oblique angle around the body. Between each rank of steel wires is a polymer mesh (an example of a spacer element) which separates one rank of steel wires from an adjacent rank. Gaps in the mesh may be filled with the HDPE matrix. The polymer mesh has a higher melting point than the matrix of HDPE. The composition of the intermediate region 120 is shown in more detail in the axial cross-section illustrated in FIG. 3. The intermediate region 120 may alternatively have one of many structures, of which some examples are described below, but in general the region has ranks of metallic components embedded in a matrix material and separated by spacer element(s). Aptly the metallic components are metal components. Aptly as an alternative metallic component are metal alloy components. Aptly as an alternative metallic components are composite components or the like.

It will be appreciated that in other embodiments, the wires may be made from any metal or material that can be heated by induction heating. It will further to be appreciated that in other embodiments, the matrix may be made from any polymer, combination of polymers, or other material having a bulk property of being bondable when exposed to heat. Also, the polymer mesh may be replaced by any insulative material having a higher melting point than the matrix. Furthermore each wire may itself be a strand or be composed of strands of wire. In still further alternative embodiments, the wires may be replaced by metallic elements of any shape, such as strips, spheres, or the like, providing the metallic elements cannot fit through holes in the mesh.

In certain embodiments, the matrix material is a thermoplastic material. In certain embodiments, the thermoplastic material is polyethylene or polypropylene or nylon or PPS or PVC or PVDF or PFA or PEEK or PTFE, alloys of such materials, or alloys of such materials with reinforcing fibres manufactured from one or more of ceramic, carbon, carbon nanotubes, aramid, steel, nickel alloy, titanium alloy, aluminium alloy or the like or fillers manufactured from ceramic, carbon, metals, buckminsterfullerenes, metal silicates, carbides, carbonates, oxides or the like.

RTP body also includes an outer sheath region 130: a polymer region used to protect the pipe against penetration of seawater and other external environments, corrosion, abrasion and mechanical damage. The outer sheath region 130 is coaxial to the intermediate region 120 and the liner region 110. As shown in FIG. 1, the outer sheath 130 is bonded with the intermediate region 120. The outer sheath is the outermost region of RTP body 100. The outer sheath 130 is made of HDPE. The outer sheath 130 may be formed by consolidating a tubular body formed using an extrusion process.

It will be appreciated that in other embodiments, the outer sheath may be made of polymer or other durable non-porous material (e.g., polyethylene, polypropylene, polyamide, or the like). Also, the tubular body consolidated to form the outer sheath 130 may be made by any known alternative process such as tape winding. Whilst the embodiment shown in FIG. 1 has three regions—the liner region 110, the thermoplastic composite intermediate region 120, and the outer sheath region 130—it will be appreciated that in some embodiments described herein, RTP body may have only the liner region 110 surrounded by ranks of parallel or helically wound metal wires, each rank separated by a polymer mesh, and covered by the outer sheath 130.

In general, each reinforced thermoplastic pipe (RTP) comprises at least one portion, referred to as a segment or section, of RTP body (which may be bonded or unbonded) together with an end fitting located at at least one end of the RTP. The end fitting provides a mechanical device which forms the transition between RTP body and a connector. The different pipe regions as shown, for example, in FIG. 1 are terminated in the end fitting in such a way as to transfer the load between RTP body and the connector.

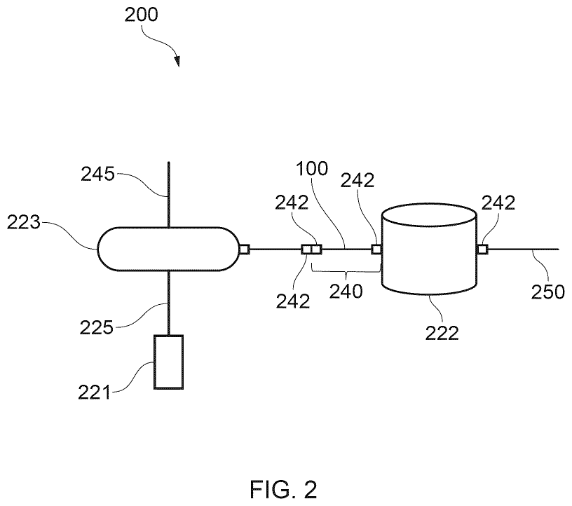

FIG. 2 illustrates an onshore assembly 200 suitable for transporting production fluid such as oil and/or gas and/or water from a wellhead production tree 221 to a storage facility 222 via a three-phase separator 223. For example, in FIG. 2, the production tree 221 includes a wellhead flow line 225. The flexible flow line 225 includes an RTP, wholly or in part, resting on the ground or buried in a trench and used in a static application. The onshore assembly 200 is provided as a spoolable pipe, that is to say an RTP 240 connecting the three-phase separator 223 to the storage facility 222. RTP 240 may optionally be composed of a segment of RTP body 100 connected to one or more end fittings 242. Aptly end fittings 242 may be joined end to end. Aptly in some embodiments one end fitting 242 may be connectable on each side to a segment of RTP body 100.

The onshore assembly 200 in FIG. 2 illustrates how portions of the RTP can be utilised as a gas export pipe 245 or an oil export pipe 250. The portions of the RTP in the onshore assembly 200 can have different pipe diameters, can withstand different pressures, and can have other specification differences according to their use. Some, though not all, examples of such configurations can be found in API 15S. It will be appreciated that in other embodiments, the RTP, RTP body and the end fittings may be used for different purposes such as water disposal pipes, gas injection pipes, produced gas pipes, CO2 export pipes, and the like.

FIG. 3 illustrates a cross-section of bonded RTP body 100. It will be appreciated that the cross-section is diagrammatic and not to scale. The central axis (axial dimension of the RTP body 100) A-A is oriented in FIG. 3 such that A-A extends into the page perpendicular to the cross-section. The concentric regions shown in FIG. 1 are visible, including the innermost liner region 110, the intermediate region 120 (which is shown in more detail), and the outer sheath region 130. It will be appreciated that in other embodiments, any layer of RTP body may be composed of a plurality of regions. The intermediate region 120 is annular, situated between the liner region 110, located radially inside the intermediate region 120, and the outer sheath region 130, located radially outside the intermediate region 120. The regions are thus coaxial.

The outer sheath region 130 of the RTP body 100 has an outer surface 310 which in use is exposed to an external environment (e.g. offshore, onshore; features such as weather conditions, water, heat, etc). The inner liner region 110 of the RTP body 100 has an inner surface 320 that defines the pipe bore 115. The pipe bore 115 in the present example is 6 inches (152.4 mm) in diameter. In other example, the pipe bore 115 may be larger or smaller than 6 inches (152.4 mm), e.g., 1, 3, 9, 12 or more inches (25.4, 76.2, 228.6, 304.8 or more millimetres). In use the inner surface 320 is usually in contact with a bore fluid. The bore fluid may be a liquid or a gas or a combination of liquid and gas.

The intermediate region 120 cross section shown in FIG. 3 has four generally concentric ranks 330₁₋₄ of steel wires 340, although other examples of the intermediate region 120 may have more (e.g. five, six, eight, etc) ranks 330. Aptly a rank may refer to a collection of elements all arranged in a circle at the same (or roughly the same) radius from the central axis A-A of the RTP body 100 when viewed in cross-section. Aptly elements in the same rank may be adjacent roughly along an imaginary circular line. The steel wires 340 in each rank 330 are arranged in respective corkscrew/helix shapes around the liner region 110. The steel wires 340 in one rank 330 are arranged in a helix with a constant lay angle of around +/−54° (relative to the longitudinal axis A-A) and a constant radius. The first rank 330₁ and the second rank 330₂ are paired, with the steel wires 340 in the first rank 330₁ having a positive lay angle whilst the steel wires 340 in the second rank 330₂ have a negative lay angle. The third rank 330₃ and the fourth rank 330₄ are similarly paired.

It will be appreciated that the steel wires 340 in a radially outer rank (e.g. the outermost rank 330₄) have a larger radius in their helical winding than a radially inner rank (e.g. the next outermost rank 330₃). It will be appreciated that the constant lay angle may be between around 5° and 85° in some examples and/or the lay angle in a rank 330 may not be constant. It will be appreciated that the lay angle may be chosen depending on the reinforcement requirements of the intermediate region 120. For example, a shallower lay angle may provide greater resistance to axial forces along RTP body.

It will further be appreciated that the steel wires 340 are an example of metallic strand elements. Aptly any electrically conductive and magnetically permeable material (e.g., copper, iron alloys, brass, etc) may be used to provide the wires 340. It will be appreciated that in other embodiments, the steel wires 340 may be exchanged for a mixture of electrically conductive fibres and non-conductive reinforcement fibres where the electrically conductive fibres provide little or no structural reinforcement to the pipe body and purely act to facilitate consolidation of pipe layers. It will be appreciated that the steel wires 340 may themselves be composed of multiple fibres threaded, twisted, or otherwise bunched together. Effectively, the material chosen for the wires should be able to be heated using induction heating.

The steel wires 340 are surrounded by a matrix material 350 made of high-density polyethylene (HPDE), although other polymers (e.g., polyethylene, polypropylene, polyamide, etc) or a material with similar properties could be used instead. The matrix material is bonded to the steel wires 340 and to the liner region 110 and the outer sheath region 130. This bonding is provided when unbonded RTP body is consolidated, causing the matrix material 350 to soften or melt when heated and join with neighbouring material when the heat source is removed.

Separating the metal wires 340 in neighbouring ranks 330 from touching are three spacer elements 360₁₋₃. The spacer element 360 effectively provides a standoff between steel wires 340 in adjacent radially outer and radially inner ranks 330. The metal wires 340 in adjacent ranks 330 are prevented from touching by the spacer elements 360. In the present example the spacer elements 360₁₋₃ are a polyester mesh lining but in other examples they could be provided with a different construction and/or material, as will be discussed below. The matrix material 350 may be located in gaps in the spacer elements 360₁₋₃ but the metal wires 340 cannot pass through these gaps. In the present example the spacer element 360 is made of polyester. Aptly the spacer element 360 may be made from a thermosetting polymer. Aptly the spacer element 360 may be made from a material with an electrical resistivity greater than the resistivity associated with the steel wires 340. Aptly the spacer element 360 may be made from a material with an electrical resistivity at least twice that of the steel wires 340. Aptly the spacer element 360 may be made from a material with an electrical conductivity less than 10% of the electrical conductivity of the steel wires 340.

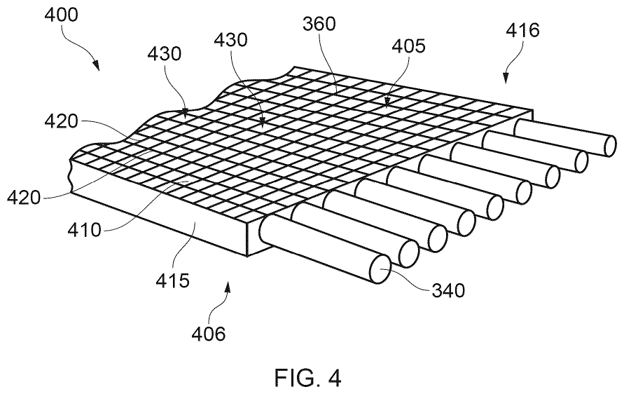

The following FIGS. 4-12 will now outline how the bonded RTP body 100 illustrated in FIGS. 1 and 3 may be made.

FIG. 4 illustrates a segment of tape 400 having a rank of nine parallel spaced apart axially extending steel wires 340 (an example of metal strand elements) embedded in a high density polyethylene (HDPE) tape body 410. It will be appreciated that the tape body 410 corresponds to the matrix material 350 once it has been consolidated. The tape body 410 forms an outer surface of the tape 400, having an upper surface 405 and a lower surface 406 and defining a thickness therebetween. Optionally the tape 400 also has at least one polyester mesh lining 360. The tape 400 is a relatively flat strip with spaced apart opposing edges 415, 416 defining a tape width therebetween. The tape 400 has a thickness that is very much smaller than the width which is very much smaller than a length dimension. In certain embodiments the ratio of width to thickness is 8 to 1 or less. In certain embodiments, the ratio is 12 to 1 or less. In some embodiments, the tape 400 has a cross-section which provides for interlocking or overlapping neighbouring windings of tape.

The steel wires 340 are shown in FIG. 4 as protruding out of the tape body 410 for illustrative purposes only and would in practice be surrounded by the tape body 410. Also, the tape 400 may have greater or fewer than nine wires 340 and they could be arranged to form more than the one rank shown in FIG. 4. The steel wires 340 extend axially in the sense that their longitudinal axes are each parallel to the longitudinal axis of the tape 400 (defining its longest dimension). The tape 400 may be consolidated to form the intermediate region 120 illustrated in FIGS. 1 and 3. It will be appreciated that in other embodiments, the tape body 410 may be made from any thermoplastic/thermosoftening polymer, any suitable polymer, or the like. For example the tape body 410 may be composed of a polyethylene, a polypropylene, or a polyamide. As previously mentioned, the steel wires 340 may be made at least in part from one or more suitable alternative materials having desirable properties such as being ferromagnetic, magnetically permeable, electrically conductive, having a sufficiently high melting point, or the like. The tape 400 may also have other reinforcement wires/fibres.

Aptly the steel wires 340 may only comprise a proportion of the reinforcements of the tape 400, for instance 10% of the fibres may comprise an electrically conductive material and the remaining reinforcements comprise a non-conductive material. In such instances it will be appreciated that the conductive material (e.g. steel wire 340) may be primarily to promote the generation of heat in the polymer matrix, and the remaining reinforcements (e.g. reinforcement wires/fibres) to provide structural strength to the bonded RTP body 100. In some embodiments the electrically conductive material may be dispersed through the thermoplastic tape material or be mainly provided around the peripheral surfaces of the tape for instance in a form of cage or net. In certain embodiments, the electrically conductive material may be provided in wires which act as weft wires interleaving and interwoven in and out of warp (longitudinally aligned) reinforcements of non-electrically conducting reinforcement fibres or strands, the tape optionally with or without the addition of a thermoplastic polymer matrix. In some embodiments, a tape including a combination of electrically conductive fibres, non-conductive reinforcement fibres and thermoplastic polymer fibres may be applied as the reinforcement tape, the heat generated through joule or induction heating melting the thermoplastic polymer fibres to provide a bond between the reinforcement layers and/or adjacent pipe layers.

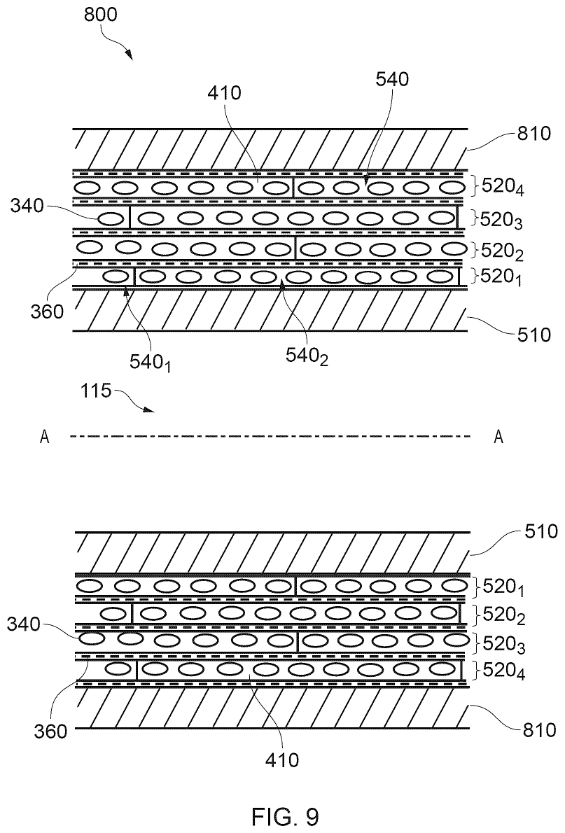

In some embodiments, the tape body 410 is bonded to the steel wires 340 through a prior heating process, for instance extrusion or pultrusion. It will be appreciated that in other embodiments, the steel wires 340 may not be bonded to the tape body 410, whereby an adhesive, friction, the addition of transverse weft element fibres woven around the wires, or the like may be used to hold the tape 400 structure together. When the tape 400 is used to form regions in bonded RTP body, a layer of wound tape(s) 400 may be heated such that the tape body 410 is melted. Thus, the tape(s) 400 bond to neighbouring layers in unbonded RTP body forming the bonded RTP body 100. An exemplary process is illustrated in FIGS. 9 to 12. It will be understood that when neighbouring layers of tape 400 are bonded together the neighbouring layers are consolidated.

The polyester mesh lining 360 is an example of a flexible and optionally windable spacer element that is supported on the upper surface 405 of the tape body 410. The mesh lining 360 is provided by interwoven thermoset polyester filaments 420 having gaps 430 between windings that effectively act like a course sieve, allowing softened matrix material to pass through/infiltrate. The gaps 430 do not necessarily need to have a specific shape (e.g. square, circular, triangular, or the like) as long as they can prevent steel wires 360 on opposing sides of the mesh from touching. Similarly, the filaments 420 of the mesh lining 360 should be thick enough to prevent steel wires 360 on opposing sides of the mesh from touching. Aptly the spacer element 360 could alternatively or additionally be supported on the lower surface 406 of the tape body 410. The spacer element 360 could be made from any thermoset polymer.

Aptly a spacer element 360 may be made from any material that meets the following criteria: (i) non-conductive; (ii) melting point higher than the tape body 410 melting point (for example above 200° C.); (iii) open mesh to allow the tape body 410 to flow through the gaps as matrix material 350 and bond neighbouring tapes 400/windings; (iv) optionally thin enough to have a negligible impact on the overall thickness of the bonded RTP body 100; (v) prevent the steel wires 340 from touching. It will be appreciated that “non-conductive” may mean in some examples that the spacer element 360 has at least twice the resistivity of the steel wire 340. In practise the spacer element 360 provides a standoff between neighbouring steel wires 340 (e.g. in concentric layers of wrapped tape 400) preventing an electrical connection between the wires. In some examples a suitable material (e.g., polyester) may be arranged in a pattern such as a 3D knit, weave, fabric, cloth, grid, porous sheet, mesh, integrally formed mesh, web, or the like. As an alternative the spacer may be provided by a flexible and optionally windable sheet or strips that are flexible and optionally windable made of zones that have different melting points. Material in some zones melts first and allows infiltration and consolidation whilst material in remaining zones does not melt at operational temperatures and these non-melted regions of the initial sheet or strips act as standoffs to prevent migration and touching of the strand like wires.

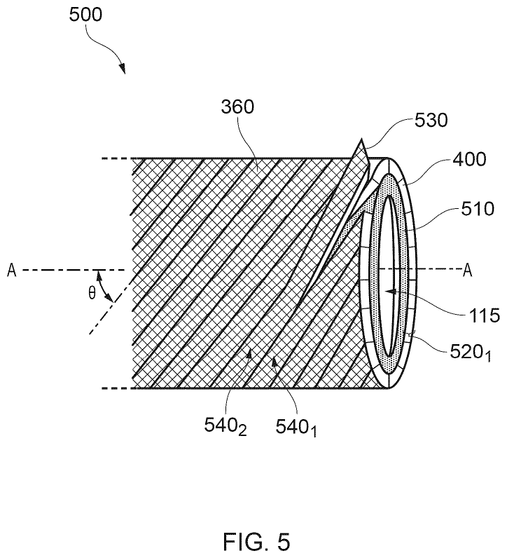

FIG. 5 illustrates partially assembled unbonded RTP body 500, in which tape 400 is helically wound around an underlying layer 510. The tape 400 windings thus form a first tape layer 520₁. In the present example, the underlying layer is a type of fluid retaining layer called a tubular liner 510. The tubular liner 510 defines the internal bore 115 that will also be present in the bonded RTP body 100.

The tubular liner 510 is formed by extruding a tubular layer of high-density polyethylene (HDPE) material. It will be appreciated that in other embodiments, the tubular liner 510 may be made from any thermoplastic, polymer, or the like (e.g., polyethylene, polypropylene, polyamide, etc). Also, other known methods for manufacturing a tube can be used instead. Generally a material should be chosen that is not porous and may soften but will not completely melt and lose its structure when the metal wires 340 are heated to consolidate unbonded RTP body.

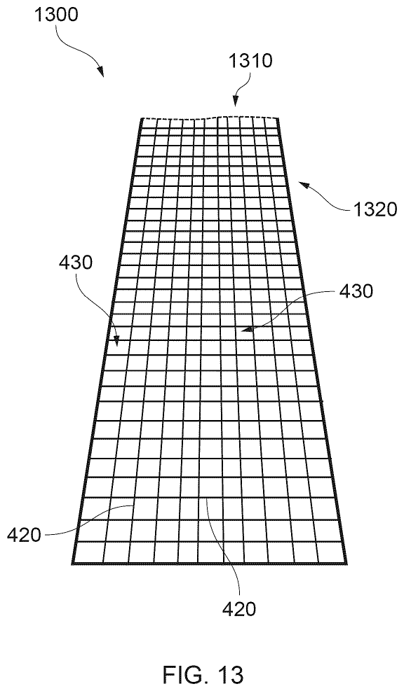

Next, the tape 400 having the polyester mesh lining 360 is helically wound around an outwardly facing surface of the tubular liner 510. As is shown in FIG. 5, an incoming tape portion 530 of the tape 400 is wound in a clockwise direction at a lay angle θ of 54°. The lay angle θ is defined as the angle between the central axis of the pipe A-A and the direction in which the tape 400 is laid defined by its longitudinal axis. It will be appreciated that in other embodiments, the magnitude of the lay angle θ may be between 5° and 85° and/or the direction of the winding may be anticlockwise. In still further embodiments tapes 400 may be laid in alignment with the central axis of the pipe A-A (see FIG. 13 for example) such that the tapes 400 are not helically wound. It will be appreciated that the lay angle θ may be chosen depending on the performance requirements of the RTP body. For example, a shallower lay angle θ may provide greater resistance to axial forces along RTP body whilst a larger lay angle θ may be more effective at resisting internal/external pressure. In the present example successive windings 540_{1,2} of the tape 400 are in contact but do not overlap. In other embodiments the windings 540 may overlap.

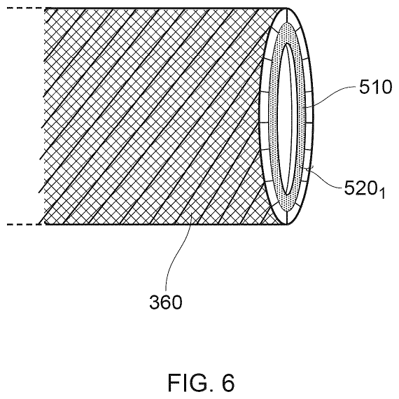

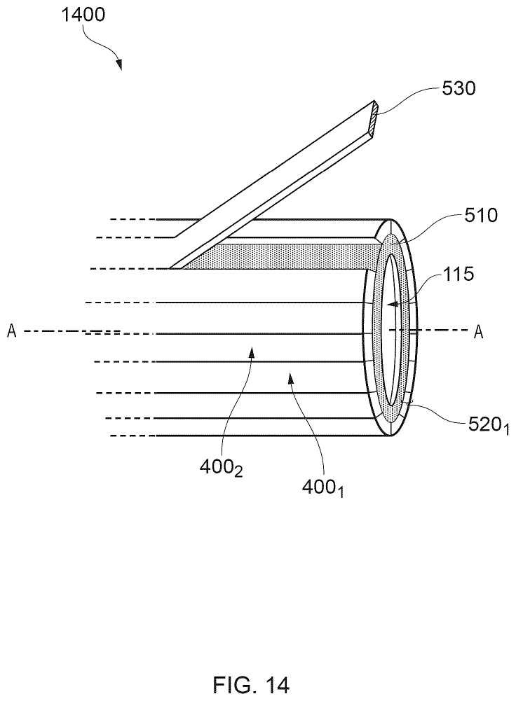

FIG. 6 illustrates how the first tape layer 520₁ is finished once the tape 400 has been helically wound around the tubular liner 510. It will be appreciated that any tape layer 520 may be formed from a single length of tape 400 that is helically wound or multiple tapes 400 that are each helically wound around the underlying layer. It will be appreciated that whilst in the present example the polyester mesh lining 360 (example of a spacer element) is part of the tape 400, in other embodiments the polyester mesh lining 360 may be provided separately (see FIGS. 13 and 14).

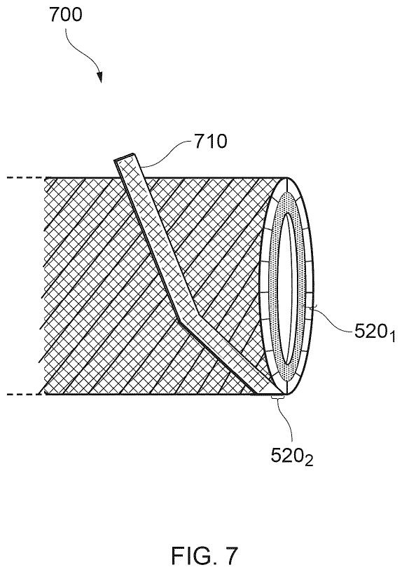

Turning to FIG. 7, a second tape layer 520₂ is formed over the previous tape layer 520₁ providing a further partially assembled unbonded RTP body 700. A new tape 400 is helically wound over an outer surface of the windings of the previous tape layer 520₁. An incoming winding 710 of the new tape 400 is wrapped in an anticlockwise direction at a lay angle θ of 54°. Effectively the new tape 400 of the second tape layer 520₂ is counter-wound in respect of the tape windings 540 of the previous tape layer 520₁. Aptly the second tape layer 520₂ may be wound in the same direction (i.e. not counter-wound) with respect to the tape windings 540 of the previous tape layer 520₁. Alternatively the second tape layer 520₂ (or indeed any tape layer 520) could be wound at a lay angle of between 5° and 85° or be placed parallel to the central axis A-A of the pipe body.

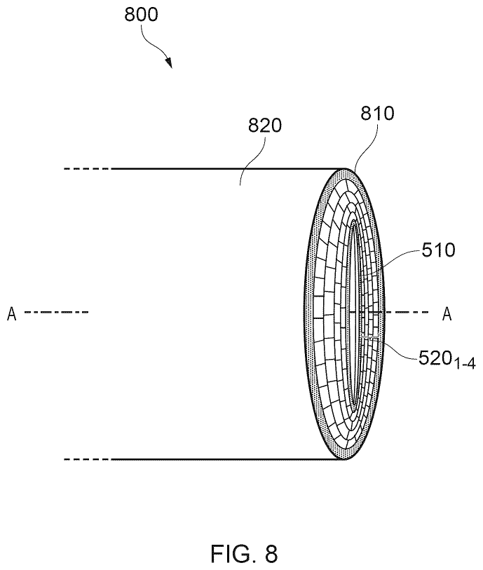

FIG. 8 illustrates a segment of full unbonded RTP body 800. As is shown in the Figure, the unbonded RTP body 800 is composed of the tubular liner 510, which forms the radially innermost layer, surrounded by four concentric tape layers 520₁₋₄, which are covered by a radially outermost outer sheath layer 810. The outer sheath layer 810 provides an outer surface 820 of the unbonded RTP body 800.

The four concentric tape layers 520₁₋₄ of the unbonded RTP body 800 are formed by helically winding a tape 400 having a polyester mesh lining 360 around an outer surface of the second tape layer 520₂ in a clockwise direction to produce a third tape layer 520₃. Then winding another tape 400 having a polyester mesh lining 360 around an outer surface of the third tape layer 520₄ in an anticlockwise direction to produce a fourth tape layer 520₄. As discussed above, the lay angles and winding directions can be changed as appropriate, or the tape layers 520 may not be counter-wound, or the tapes 400 may be placed parallel to the central axis A-A.

The outer sheath layer 810 is formed by extruding a tubular layer of high-density polyethylene (HDPE) material over the outermost tape layer 520₄. It will be appreciated that in other embodiments, the outer sheath layer 810 may be made from any thermoplastic, polymer, or the like (e.g., polyethylene, polypropylene, polyamide, etc). Also, other known methods for manufacturing a tube can be used instead. For example a pre-formed tube could be provided as the outer sheath layer 810 and slid over the outside of the outermost tape layer 520₄. Generally, a material should be chosen for the outer sheath layer 810 that is not porous and may soften but will not completely melt and lose its structure when the metal wires 340 are heated to consolidate the unbonded RTP body 800.

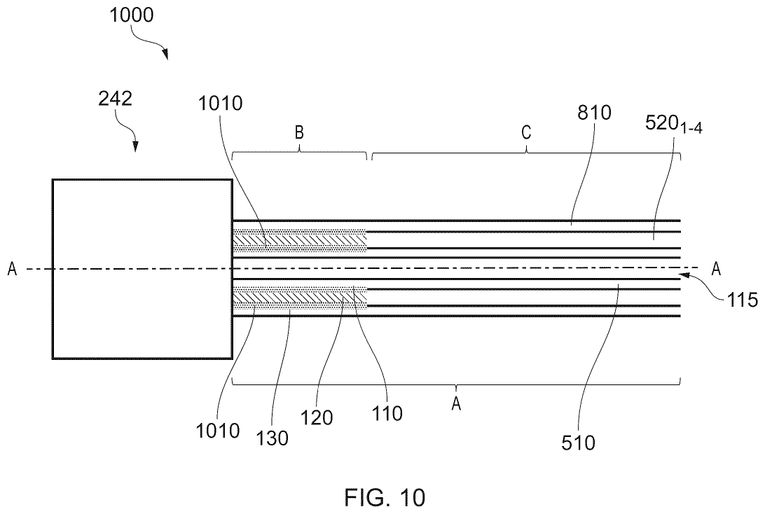

It will also be appreciated that in some instances it is desirable to use unbonded RTP body 800 without consolidating it. This may allow the layers 510, 520₁₋₄, 810 to slide freely past one another, improving flexibility. In the present example, part of the segment of unbonded RTP body 800 is consolidated whilst a remaining segment is maintained as unbonded RTP body (see FIG. 10). In other examples the whole segment of unbonded RTP body 800 may be consolidated to provide a whole segment of consolidated RTP body 100.

Turning to FIG. 9, a longitudinal cross-section of the segment of unbonded RTP body 800 is illustrated. The unbonded RTP body 800 has concentric layers of the tubular liner 510 surrounded on a radially outer surface by two counter-wound pairs of concentric tape layers 520₁₋₄ and enclosed by the outer sheath layer 810.

Each tape layer 520 has tape windings 540 of the tape 400 which have been helically wound around an underlying layer. As is shown in FIG. 9, neighbouring windings (for example the first winding 540₁ and the second winding 540₂ in the first tape layer 520₁) are in abutment with each other. In some embodiments, neighbouring tape windings 540 may overlap or there may be a gap between windings 540. Also there could alternatively be two, three, four, five, six or more tape layers 520 in the unbonded RTP body 800. Aptly the tape 400 that is wound in the tape layers 520 may have any number of steel wires 340 (or other metallic wires/strands). Between each tape layer 520 is a polyester mesh lining 360 which prevents steel wires 340 in neighbouring tape layers 520 from touching during consolidation. The polyester mesh lining 360 has a negligible thickness relative to the tape layers 520.

It will also be appreciated that in some embodiments, the space between the tubular liner layer 510 and the outer sheath layer 810 may comprise conductive fibres or strands or bunches of fibres which may be applied to the pipe without being incorporated into a tape (i.e. without a polymer matrix around the fibres). That is to say in some examples unbonded RTP body 800 may be composed of (from radially inside to outside): the tubular liner 510, a first layer of wound steel wire 340 not surrounded by tape body 410, a length of polyester mesh lining 360 (which could be wound over the outside of the first layer of steel wire); a second layer of wound steel wire 340 not surrounded by tape body 410; a length of polyester mesh lining 360; a third layer of wound steel wire 340; a length of polyester mesh lining 360; a fourth layer of wound steel wire 340; and the outer sheath layer 810. Although the alternative example given has four layers of steel wire 340 there could of course be a different number of layers of steel wire 340.

FIG. 10 illustrates how unbonded RTP (having a segment of unbonded RTP body and an optional end fitting 242) may be partially consolidated forming partially consolidated RTP body 1000. In particular, part of a segment A of unbonded RTP body 800 may be consolidated to form a sub-segment B of bonded RTP body 100 and a remaining sub-segment C of unbonded RTP body 800. It will be appreciated that FIG. 10 is a simplified diagrammatic illustration that does not show specific details such as individual tape layers, steel wires, or the like. In the sub-segment B of bonded RTP body 100, regions 110, 120, 130 are joined together. There may be one or more bonding zones 1010 at boundaries between the regions, where elements of neighbouring regions 110, 120, 130 intermingle. For example, part of the HDPE tape body 410 may, when softened, migrate into part of the outer sheath layer 810. Or part of the HDPE tape body 410 may migrate into part of the inner liner layer 510.

A segment of the unbonded RTP body 800 is consolidated by heating material in the body to 135° C. (or alternatively 120° C., 150° C., under 200° C., or the like). This causes the HDPE tape body 410, the outer sheath layer 810, and the inner liner layer 510 to soften and consolidate together. The lengths of polyester mesh lining 360 prevent a rank of steel wires 340 from touching a different rank of steel wires 340. The polyester mesh lining 360 has a melting point that is higher than the melting point of the material that is softened (e.g., the tape body 410 and/or the outer sheath layer 810 and/or the inner liner layer 510). The melting point of the polyester mesh lining 360 is above 200° C. Aptly the polyester mesh lining 360 is made from a material that has a melt temperature of more than 120° C. Aptly the polyester mesh lining 360 is made from a material that has a melt temperature of more than 135° C. Aptly, a material of the polyester mesh lining 360 has a melt temperature equal to or greater than a melt temperature associated with an underlying layer (e.g., tape body 410, inner liner layer 510, or the like) over which the tape element is wound.

It will be appreciated that in other embodiments, a segment of unbonded RTP body 800 may be completely consolidated (forming an equal length segment of bonded RTP body 100). In still further embodiments, multiple spaced apart sub-segments of the segment of unbonded RTP body 800 may be consolidated forming respective sub-segments of bonded RTP body 100. The location of the sub-segment B of bonded RTP body 100 within the overall segment A may be moved away from an end of the unbonded RTP body 800 as desired.

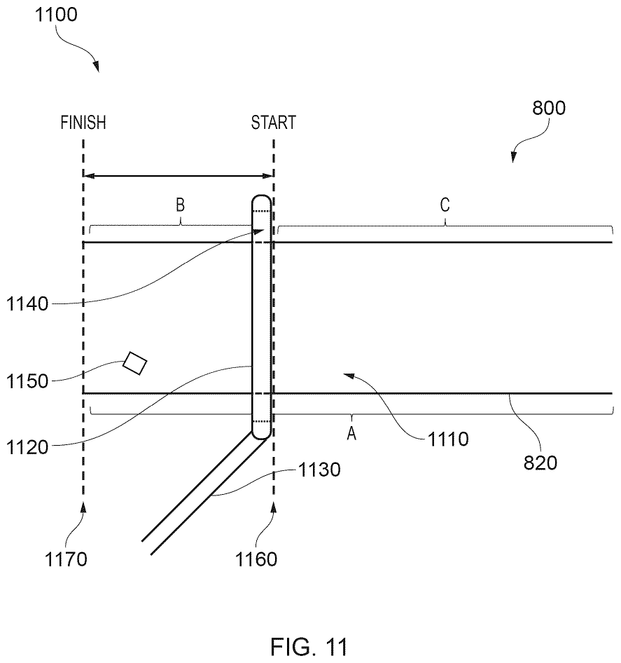

FIG. 11 illustrates a method 1100 of consolidating initially unbonded RTP body 800 using an induction heater 1110. The segment A of unbonded RTP body 800 is shown from a side view. The induction heater 1110 has an induction heating coil 1120 that is powered by attached power cables 1130, which are attached to a power source (not shown). The induction heating coil 1120 has a single winding of copper tubing, although it will be apparent that multiple windings could be used instead. Water (or alternatively another fluid) flows through the copper tubing to cool the coil 1120 in use. Aptly, the copper tubing may alternatively be replaced with tubing formed from another suitable material, conductive wiring, or the like. The segment A of unbonded RTP body 800 is located in an aperture 1140 of the induction heating coil 1120. The induction heater 1110 is energised by applying a high-frequency alternating current through the induction heating coil 1120 via the power cables 1130. The changing current creates a changing circular magnetic field perpendicular to the direction of current flow through the induction heating coil 1120. Overall, the magnetic field is thus centred along the axis of the induction heating coil 1120 and effectively toroidal in shape.

It will be appreciated that the frequency of the alternating current and the potential difference (voltage) between ends of the coil 1120 may be varied depending on the properties of the unbonded RTP body 800, mode of operation of the induction heater 1110, desired degree of bonding of the bonded RTP body 100 and the like. It will be appreciated that changing properties of the alternating current affects the magnitude and orientation of the induced magnetic field.

One or more optional temperature sensing devices 1150 (e.g. thermocouples) may be placed along the unbonded RTP body 800 to monitor the temperature of various regions of the body and prevent a maximum temperature from being reached. It will be appreciated that the temperature measurements may be used to determine the frequency and magnitude of current through the induction heating coil 1120.

It will be appreciated that there are various other known induction heating arrangements that could alternatively be used to heat the steel wires 340 of unbonded RTP body 800 and thereby produce bonded RTP body 100. For example, one or more induction heating coils could be placed in a stationary position on the outer surface 820 of the unbonded RTP body 800, energised to consolidate a small section of the unbonded RTP body 800, de-energised, moved to another stationary position and re-energised.

Referring to FIGS. 10 and 11, the segment A of unbonded RTP body 800 may be consolidated using induction heating according to one example as follows.

The segment A may be secured in a jig to prevent movement of the segment A during the induction heating process. The induction heating coil 1120 is located around the unbonded RTP body 800 at a start location 1160 such that the RTP body 800 passes through the aperture 1140 of the induction heating coil 1120.

The induction heater 1110 is then energised by passing an alternating current of predetermined magnitude and frequency through the induction heating coil 1120. The alternating current in the induction heating coil 1120 creates a changing circular magnetic field perpendicular to the direction of the current passing through the coil. Whilst the induction heating coil 1120 is energised, an electrical current is induced in the steel wires 340 (or other metal components) of the unbonded RTP body 800. Due to the changing nature of the magnetic field eddy currents are induced in the electrically conductive steel wires 340. The eddy currents heat the steel wires 340 by Joule heating. Due to the heating of the steel wires 340, the surrounding tape body 410 in each of the tape layers 520₁₋₄ is heated until it reaches its glass transition temperature and begins to soften. The tubular liner 510 and/or the outer sheath layer 810 may also be softened by the heated steel wires 340. At this stage the tape layers 520₁₋₄ bond to adjacent layers (e.g. neighbouring tape layers 520, tubular liner layer 510, outer sheath layer 810, or the like) in the unbonded RTP body 800. Aptly, the electrically conductive steel wires 340 are heated by another form of Joule heating in which an electrical current is directly applied through the steel wires 340. It will be appreciated that Joule heating is resistive heating.

The induction heating coil 1120 is moved, whilst it is energised, at a predetermined steady speed horizontally from the start location 1160 to a finish location 1170. This allows the whole length of the sub-segment B to be evenly heated internally. Optionally, the induction heating coil 1120 may be moved in repeated passes from the start location 1160 to the finish location 1170 and back to the start location 1160. This can help to mitigate the effects of uneven heating throughout the axial cross-section of the unbonded RTP body 800 by allowing time for hotter regions to transfer heat to cooler regions. Therefore no component of the unbonded RTP body 800 is heated above its desired maximum temperature.

Optionally rollers may be applied to the external surface of the RTP body just after the induction heating process in order to apply pressure to the viscous state thermoplastic polymer of the intermediate region 120 and/or the inner liner region 110 and/or the outer sheath region 130 to improve consolidation and bonding.

When the induction heating process is finished, the induction heater 1110 is de-energised and removed from the resulting partially consolidated RTP body 1000. Then the partially consolidated RTP body 1000 may be terminated in the end fitting 242.

It will be appreciated that the start location 1160 and the finish location 1170 are chosen depending on where the sub-segment B of bonded RTP body 100 is to be positioned. If there are to be multiple spaced apart sub-segments B of bonded RTP body 100, the induction heating coil 1120 may be positioned at a first start location, energised, moved steadily to a first finish location, then de-energised, moved to a second start location and the process repeated for each of the spaced apart sub-segments B of bonded RTP body 100. Alternatively, if the whole segment A of unbonded RTP body 800 is to be consolidated, the start location 1160 may be at one free end of the unbonded RTP body 800 and the finish location 1170 at the opposite free end of the unbonded RTP body 800. In other embodiments, the unbonded RTP body 800 may be consolidated after the body 800 has been terminated at an end fitting 242. This may be particularly helpful when it is desired to consolidate a fully assembled unbonded reinforced thermoplastic pipe (RTP), for example, after being manufactured and/or stored.

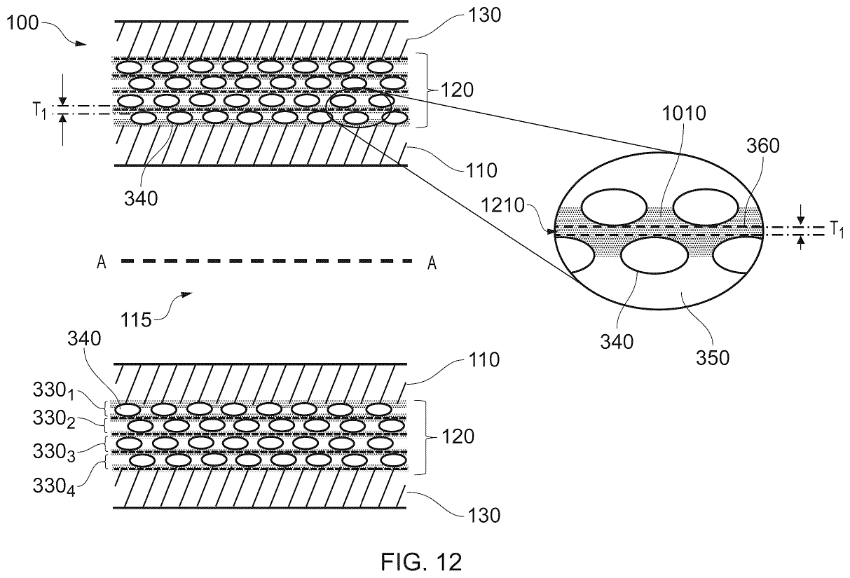

FIG. 12 illustrates a longitudinal cross-section of a segment of bonded RTP body 100. The liner region 110 is bonded to the intermediate region 120 which is bonded to the outer sheath region 130. The bonded RTP body 100 has four radially spaced apart ranks 330₁₋₄ of helically wound steel wires 340 which are embedded in the matrix material 350. Neighbouring ranks 330₁₋₄ of steel wires 340 are prevented from touching each other by the lengths of polyester mesh lining 360 (an example of a spacer element).

The polyester mesh lining 360 maintains a gap 1210 of a predetermined thickness T₁ between neighbouring ranks 330₁₋₄ of steel wires 340 when the unbonded RTP body 800 is consolidated during induction heating. Aptly the polyester mesh lining 360 has a predetermined thickness T₁. Aptly the predetermined thickness T₁ of the gap 1020 may be 0.01 mm, 0.01 mm, 0.1 mm, 1 mm, 10 mm, or the like. The polyester mesh lining 360 helps to prevent the steel wires 340 from touching during the induction heating process. This helps to increase the effectiveness of the induction heater at heating the whole of the unbonded RTP body 800 to the correct temperature. As such the quality of bonding in bonded RTP body 100 is improved relative to a known technique by using the lengths of polyester mesh lining 360.

The polyester mesh lining 360 allows softened/fluid tape body 410 pass through it during induction heating, so the lining 360 is infiltrated with matrix material 350 in the bonded RTP body 100. Bonding zones 1010 are also formed where material from one softened material (e.g., tape body 410, tubular liner layer 510, outer sheath layer 810, or the like) blends into another softened material. This helps to improve the quality of bonding. Thus bonded RTP body 100 is formed.

FIG. 13 illustrates a polyester mesh strip 1300 (another example of a spacer element or a spacer element strip). The polyester mesh strip 1300 is effectively the same as the previously-described polyester mesh lining 360, except that the mesh strip 1300 is not affixed or integral to tape 400 and is instead a standalone strip of material. The polyester mesh strip 1300 is still made from interwoven thermoset polyester filaments 420. The polyester filaments 420 have a greater electrical resistance than the steel wires 340. The polyester filaments 420 provide the alternative polyester mesh lining 1300 with its thickness T₁. The thickness T₁ is sufficient to prevent a steel wire 340 pressed against a first surface 1310 of the strip 1300 from physically contacting a second steel wire 340 pressed against an opposite surface 1320 of the strip 1300.

To form unbonded RTP body 800 using the polyester mesh strip 1300, a first tape layer 520₁ having a tape body 410 and embedded axially extending steel wires 340 only may be wound over the (underlying) tubular liner 510 (similar to that illustrated in FIG. 5). Then a length of the polyester mesh strip 1300 may be helically wound (or otherwise wrapped or placed) over the first tape layer 520₁. Then a second tape layer 520₂ having a tape body 410 and embedded axially extending steel wires 340 only may be wound over the (underlying) first tape layer 520₁. Then a length of the polyester mesh strip 1300 may be helically wound (or otherwise wrapped or placed) over the second tape layer 520₂. The same process is repeated for the third and fourth tape layers 520₃₋₄, being separated by the polyester mesh strip 1300 until the unbonded RTP body 800 illustrated in FIG. 8 is produced. This can then be consolidated in the same way as previously described.

It will be appreciated that the polyester mesh strip 1300 could be rolled into a tube shape and slid over a tape layer 520. Aptly the polyester mesh strip 1300 could be replaced by a perforated tube having holes for matrix material 350 to infiltrate.

FIG. 14 illustrates a segment of an alternative partially assembled unbonded RTP body 1400. The alternative partially assembled unbonded RTP body 1400 effectively corresponds to the partially assembled unbonded RTP body 500 illustrated in FIG. 5, except that the lengths of tape 400 are not wound helically but are instead extend lengthwise along the body 1400 parallel to the central axis A-A. It will be appreciated that the lengths of tape 400 may be adhered or otherwise secured to an underlying layer prior to the unbonded RTP body being consolidated.

As is shown in FIG. 14, the incoming tape portion 530 of tape 400 is laid down parallel to the axis of the (underlying) tubular liner 510. A first tape 4001 is placed on an outer surface of the tubular liner 510 parallel to the central axis A-A. A second tape 4002 is placed on the outer surface of the tubular liner 510 adjacent to and in contact with the first tape 4001. Aptly the tapes 400 may overlap or there may be a gap between some neighbouring tapes 400. It will be appreciated that further layers of tape 520₂₋₄ are placed in a similar fashion. The further layers of tape are placed such that the join/gap between two adjacent tapes 400 in the same layer 520 is covered by a tape 400 in a neighbouring tape layer 520. Further, the tapes 400 are provided without the polyester mesh lining 360 (as illustrated in FIG. 14), in which case the polyester mesh strip 1300 is placed between the tape layers 520 as described above. Aptly the tapes 400 may be provided with the polyester mesh lining 360 (similar to that illustrated in FIG. 5), meaning the polyester mesh strip 1300 does not need to be separately placed. After the four tape layers 520₁₋₄ have been positioned, the outer sheath layer 810 is slid or extruded over the top. The resulting alternative unbonded RTP body may be consolidated according to any method previously described.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

While certain arrangements of the inventions have been described, these arrangements have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, arrangement, or example are to be understood to be applicable to any other aspect, arrangement or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing arrangements. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some arrangements, the actual steps taken in the processes illustrated and/or disclosed may differ from those shown in the figures. Depending on the arrangement, certain of the steps described above may be removed, others may be added. Furthermore, the features and attributes of the specific arrangements disclosed above may be combined in different ways to form additional arrangements, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular arrangement. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain arrangements include, while other arrangements do not include, certain features, elements, and/or steps. Thus, such conditional language is not generally intended to imply that features, elements, and/or steps are in any way required for one or more arrangements or that one or more arrangements necessarily include logic for deciding, with or without user input or prompting, whether these features, elements, and/or steps are included or are to be performed in any particular arrangement.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain arrangements require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may be used to refer to an amount that is within less than 10% of the stated amount. As another example, in certain arrangements, the terms “generally parallel” and “substantially parallel” refer to a value, amount, or characteristic that departs from exactly parallel by less than or equal to 15°, 10°, 5°, 3°, 1 degree, or 0.1 degree. The ranges disclosed herein also encompass any and all overlap, sub-ranges, and combinations thereof, and any specific values within those ranges. Language such as “up to,” “at least,” “greater than,” “less than,” “between,” and the like includes the number recited. Numbers and values used herein preceded by a term such as “about” or “approximately” include the recited numbers. For example, “approximately 7 mm” includes “7 mm” and numbers and ranges preceded by a term such as “about” or “approximately” should be interpreted as disclosing numbers and ranges with or without such a term in front of the number or value such that this application supports claiming the numbers, values and ranges disclosed in the specification and/or claims with or without the term such as “about” or “approximately” before such numbers, values or ranges such, for example, that “approximately two times to approximately five times” also includes the disclosure of the range of “two times to five times.” The scope of the present disclosure is not intended to be limited by the specific disclosures of preferred arrangements in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A flexible pipe member, comprising:
a liner region;
an outer sheath region; and
an intermediate region between the liner region and the outer sheath region; wherein
the intermediate region comprises a plurality of radially spaced apart ranks of metallic strand elements embedded in polymer matrix material and at least one spacer element, infiltrated with the matrix material, that provides a standoff between respective metallic strand elements in adjacent radially outer and radially inner ranks of the plurality of ranks.

2. The flexible pipe member as claimed in claim 1, further comprising:
the spacer element is made from a material with an electrical resistance or electrical impedance or electrical resistivity that is greater than a respective electrical resistance or electrical impedance or electrical resistivity associated with the metallic strand elements, or that is greater than a respective electrical resistance or electrical impedance or electrical resistivity of at least two of the metallic strand elements when said at least two of the metallic strand elements are in contact.

3. The flexible pipe member as claimed in claim 1, further comprising:
one or more respective spacer elements of the at least one spacer element comprises a respective spacer web and optionally the spacer web comprises a plurality of filaments.

4. The flexible pipe member as claimed in claim 1, further comprising:
the plurality of radially spaced apart ranks of metallic strand elements are circumferentially extending ranks.

5. The flexible pipe member as claimed in claim 1, further comprising:
the intermediate region comprises a plurality of metallic strand elements helically wound in ranks that each extend axially along the flexible pipe body at a respective predetermined radially constant distance from a central axis associated with a central bore of the flexible pipe body.

6. The flexible pipe member as claimed in claim 1, further comprising:
the at least one spacer element comprises a plurality of spacer elements each comprising a respective perforated tube, each perforated tube extending at a respective constant radius along the flexible pipe body between a respective two of the plurality of ranks and optionally each respective perforated tube has a respective diameter associated with that tube, and each respective diameter is different in size to a diameter of any other respective perforated tube and optionally each respective perforated tube is coaxially arranged with each remaining respective perforated tube.

7. The flexible pipe member as claimed in claim 1, further comprising:
the liner region comprises a tubular region of a polymer liner material; and
the outer sheath comprises a tubular region of a polymer sheath material; and
the polymer matrix material is respectively consolidated with the liner material and the sheath material at respective interfaced zones where the liner region blends into the matrix material of the intermediate region and where the outer sheath region material blends into the matrix material of the intermediate region.

8. A tape element, comprising:
a flexible elongate polymer tape body having a first edge spaced apart from a remaining edge;
a plurality of metallic strand elements embedded in, and extending axially in a parallel spaced apart relationship within, the tape body; and
at least one flexible spacer element each supported on a respective one side of the tape body.

9. The tape element as claimed in claim 8, further comprising:
the spacer element comprises a spacer web and optionally the spacer web comprises a strip comprising a plurality of interwoven or interconnected filaments.

10. The tape element as claimed in claim 8, further comprising:
the spacer element is manufactured from an electrically insulating material.

11. The tape element as claimed in claim 8, further comprising:
a material of the spacer element has a melt temperature of more than 120° C. or more than 135° C. or more than 200° C.

12. The tape element as claimed in claim 9, further comprising:
the spacer element comprises a plurality of through openings that extend from a first side of the spacer element proximate to said a respective one side of the tape body to a remaining side of the spacer web distal to said a respective side.

13. The tape element as claimed in claim 8, wherein the flexible elongate polymer tape body is a windable elongate polymer tape body and the at least one flexible spacer element is at least one respective windable flexible spacer element.

14. A method of manufacturing a flexible pipe member, comprising the steps of:
extruding a tubular layer of a polymer liner material thereby providing a tubular liner;
providing a plurality of layers of windings over the liner, each layer of the layers of windings being provided by helically winding a respective tape element, that comprises a plurality of metallic strand elements embedded in and axially extending in a spaced apart substantially parallel relationship within an elongate polymer tape body, over an underlying layer;
extruding a tubular layer of a polymer outer sheath material as an outer sheath over an outer layer of the layers of windings;
via induction heating, heating at least a predetermined axial length of said a plurality of layers of windings, thereby melting and consequently consolidating tape body material that comprises polymer material of polymer from the tape body of the layers of windings; and
as the tape body material melts, providing a standoff between metallic strand elements in adjacent ranks of metallic strand elements, each rank being associated with embedded metallic strand elements of tape windings of a respective one of the plurality of layers of windings.

15. The method as claimed in claim 14, further comprising:
via providing the standoff between metallic strand elements in adjacent ranks of metallic strand elements, providing a standoff, between metallic strand elements in adjacent ranks of metallic strand elements, that has an electrical resistivity or electrical impedance or electrical resistance that is greater than a respective electrical resistivity or electrical impedance or electrical resistance associated with the metallic strand elements, or that has an electrical conductance or electrical conductivity that is less than a respective electrical conductance or electrical conductivity associated with the metallic strand elements.

16. The method as claimed in claim 14, further comprising:
providing at least one spacer element between metallic strand elements of at least one pair of adjacent ranks prior to extruding the outer sheath and optionally providing at least one spacer element between at least one pair of adjacent layers of windings and/or providing at least one spacer element by providing at least one spacer web and/or providing a respective spacer element between metallic strand elements of each pair of adjacent ranks.

17. The method as claimed in claim 14, further comprising:
providing the spacer element by winding a first tape element that comprises a spacer element strip supported on at least one side of the tape element prior to winding a further tape element of the next respective layer thereby providing the standoff.

18. The method as claimed in claim 14, further comprising:
prior to winding a further tape element of the next respective layer, providing the spacer element by winding a first tape element that comprises a first spacer element strip supported on a first side of the tape element, and a further spacer strip supported on a further side of the tape element, that is an opposite side relative to the first side, thereby providing the standoff.

19. The method as claimed in claim 14, further comprising:
heating the at least a predetermined axial length of said a plurality of layers of windings via imparting an electrical current in a coil element disposed radially outside of the outer sheath or radially inside the tubular liner, thereby inducing an electrical current in at least one of the metallic strand elements and optionally inducing an electrical current in at least one of the metallic strand elements comprises inducing an electrical current in each of the metallic strand elements of each rank and/or imparting an electrical current in the coil element comprises imparting an electrical current in at least one turn of a coil element that comprises at least one turn formed from electrically conducting material.

20. The method as claimed in claim 19, further comprising:
axially urging at least a portion of an axial length of the tubular liner relative to the coil element thereby heating at least one of the metallic strand elements disposed radially around said at least a portion of the axial length of the tubular liner.
